(19) United States
(12) Patent Application Publication
(10) Pub. No.: US 2009/0016577 A1
(43) Pub. Date: Jan. 15, 2009

(54) COLLATION SYTEM AND COMPUTER READABLE MEDIUM STORING THEREON PROGRAM

(75) Inventors: Kazuhiro Mino, Kanagawa (JP); Shuji Ono, Kanagawa (JP); Toshihiko Kaku, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/187,640

(22) Filed: Aug. 7, 2008

Related U.S. Application Data
(62) Division of application No. 10/951,617, filed on Sep. 29, 2004, now abandoned.

(30) Foreign Application Priority Data
Sep. 29, 2003 (JP) 2003-338708
Sep. 10, 2004 (JP) 2004-264511

(51) Int. Cl. G06K 9/00

(52) U.S. Cl. 382/118; 382/209; 707/104.1

(57) ABSTRACT

A collation system for selecting a registrant matched with a passer-by among a plurality of registrants registered in advance includes a photographing section for photographing the passer-by, a candidate searching section for searching a plurality of candidates for the registrant matched with the passer-by among the plurality of registrants based on a first image of the passer-by photographed by the photographing section, and a passer-by collating section for selecting the registrant matched with the passer-by among the plurality of candidates based on a second image of the passer-by photographed by the photographing section when the passer-by is closer to the photographing section than when the first image is photographed.

This patent application claims priority from Japanese patent applications Nos. 2003-338708 filed on Sep. 29, 2003 and 2004-264511 filed on Sep. 10, 2004, the contents of which are incorporated herein by reference.

### BACKGROUND OF THE INVENTION

1. Field of the Invention

The present invention relates to a collation system and a computer readable medium storing thereon program. More particularly, the present invention relates to a collation system and a computer readable medium storing thereon program for selecting a registrant matched with a passer-by among a plurality of registrants registered in advance.

2. Description of the Related Art

As a conventional method for permitting only a registrant registered in advance, one of photographing the face, etc., of a passer-by, collating with a registrant registered in advance and authenticating the passer-by has been proposed. As an example of the collating process, Japanese Patent Application Laid-Open No. 2003-58888 proposes a method of weighting a plurality of feature amounts based on the feature of a passer-by, when collating a plurality of feature amounts extracted from the face image, etc., of the passer-by with the plurality of feature amounts of a registrant.

In order to accurately perform the collation on the passer-by with the registrant, more features are required. Further, if a passer-by is authenticated to enter a company building, etc., based on the collation result, it is required to perform the collation on the passer-by with a large number of registrants, so that is takes time for the collation process.

### SUMMARY OF THE INVENTION

Therefore, it is an object of the present invention to provide a collation system and a computer program thereof, which is capable of overcoming the above drawbacks accompanying the conventional art. The above and other objects can be achieved by combinations described in the independent claims. The dependent claims define further advantageous and exemplary combinations of the present invention.

According to a first aspect of the present invention, a collation system for selecting a registrant matched with a passer-by among a plurality of registrants registered in advance includes a photographing section for photographing the passer-by, a candidate searching section for searching a plurality of candidates for the registrant matched with the passer-by among the plurality of registrants based on a first image of the passer-by photographed by the photographing section and a passer-by collating section for selecting the registrant matched with the passer-by among the plurality of candidates based on a second image of the passer-by photographed by the photographing section when the passer-by is closer to the photographing section than when the first image is photographed.

The collation system may further include a feature selecting section for selecting a comparison feature among a plurality of predetermined features, the comparison feature being compared to select the registrant matched with the passer-by, based on a feature amount of each of the plurality of candidates for each of the plurality of features, wherein the passer-by collating section may include a feature amount calculating section for calculating a feature amount of the passer-by for the comparison feature from the second image and a matched registrant selecting section for selecting the registrant matched with the passer-by among the plurality of candidates based on a result of comparing the feature amount of the passer-by with the feature amount of each of the plurality of candidates with respect to the comparison feature.

The feature selecting section may select one of the plurality of features as the comparison feature, with respect to which the variance of feature amounts of the plurality of candidates is larger than a predetermined value.

The collation system may further include a weight determining section for determining a weight given to each of a plurality of predetermined features, the weight being used to select the registrant matched with the passer-by, based on a feature amount of each of the plurality of candidates for each of the plurality of features, wherein the passer-by collating section may include a feature amount calculating section for calculating a feature amount of the passer-by for each of the plurality of features from the second image and a matched registrant selecting section for selecting the registrant matched with the passer-by among the plurality of candidates based on both a result of comparing the feature amount of the passer-by with the feature amount of each of the plurality of candidates with respect to each of the plurality of features and the weight given to each feature.

The weight determining section may make a weight given to one of the plurality of features, with respect to which variance of feature amounts of the plurality of candidates is relatively large, be larger than a weight given to another one of the plurality of features, with respect to which variance of feature amounts of the plurality of candidates is relatively small.

The passer-by collating section may include a feature amount calculating section for calculating a feature amount of the passer-by for each of a plurality of predetermined features from the second image, a feature selecting section for selecting one of the plurality of features, with respect to which deviation of the feature amount of the passer-by from a feature amount of each of the plurality of registrants is largest, as a comparison feature to be compared to select the registrant matched with the passer-by and a matched registrant selecting section for selecting the registrant matched with the passer-by based on the feature amount of the passer-by and a feature amount of each of the plurality of candidates with respect to the comparison feature.

The collation system may further include a comparing section for comparing the first and second images and making the first and second images correspond to each other if the passers-by photographed are identical, wherein the passer-by collating section may select the registrant based on the second image among the candidates searched by the candidate searching section based on the first image corresponding to the second image.

The photographing section may further photograph a comparison image which results from photographing the second image of the passer-by so that the second image have a substantially same area as the first image, the collation system may further include a comparing section for comparing the first image and the comparison image and making the first and second images correspond to each other if the passers-by photographed are identical, and the passer-by collating section may select the registrant based on the second image from the candidates searched by the candidate searching section based on the first image.

If a plurality of the passers-by is photographed on the first image, the candidate searching section may extract candidates for each of the passers-by, the collation system may further include a comparing section for making each of the passers-by photographed on the first image and the passer-by photographed on the second image correspond to each other based on the first and second images, and the passer-by collating section may select one of the candidates based on the second image, the candidates being searched by the candidate searching section for the passers-by photographed on the first image corresponding to the passer-by photographed on the second image. The photographing section may photograph the second image for each of the passers-by.

The photographing section may include a flashlight section for projecting light onto the passer-by and a flashlight control section for controlling a position of the flashlight section to project light onto the passer-by and the intensity of light projected onto the passer-by, the candidate searching section may detect brightness of the first image, and the flashlight control section may control the intensity of light projected by the flashlight section when the photographing section photographs the second image based on the brightness of the first image.

The flashlight section may be able to project light onto the passer-by from a plurality of positions, and the flashlight control section may control the positions of the flashlight section to project light when the photographing section photographs the second image based on the brightness of the first image.

The candidate searching section may detect the brightness of a part of the first image corresponding to a part of the passer-by used for the collation of the passer-by collating section, and the flashlight control section may control the positions of the flashlight section to project light based on the brightness of the part of the first image.

The candidate searching section may detect the brightness of a part of the first image corresponding to a part of the passer-by used for collation of the passer-by collating section, and the flashlight control section may control the intensity of light projected by the flashlight section based on the brightness of the part of the first image.

The candidate searching section may detect the contrast of a part of the first image corresponding to a part of the passer-by used for collation of the passer-by collating section, and the flashlight control section may control the positions of the flashlight section to project light based on the contrast of the part of the first image.

The candidate searching section may detect the contrast of a part of the first image corresponding to a part of the passer-by used for collation of the passer-by collating section, and the flashlight control section may control the intensity of light projected by the flashlight section based on the contrast of the part of the first image.

The photographing section may be able to photograph the passer-by at a plurality of heights, and the candidate searching section may detect a position of the passer-by on the first image, calculate a height of the photographing section to photograph the passer-by based on the detected position of the passer-by, and control a height of the photographing section to photograph the passer-by when photographing the second image based on the height calculated.

The passer-by collating section may include a registered image database for storing a plurality of registered images photographed in advance under different conditions for each of the candidates, a position calculating section for calculating a position of the passer-by when the photographing section photographs the second image of the passer-by based on the first image, a lighting condition calculating section for calculating a lighting condition when the photographing section photographs the second image of the passer-by based on the position of the passer-by calculated by the position calculating section, a registered image selecting section for selecting in advance one of the registered images from the registered image database for each of the candidates searched by the candidate searching section, the registered image to be selected corresponding to the lighting condition calculated by the lighting condition calculating section, and a matched registrant selecting section for selecting the registrant from the candidates using the registered image selected by the registered image selecting section.

The passer-by collating section may include a match degree calculating section for calculating a degree of match between the passer-by and each of the candidates based on the second image, a feature obtaining section for further obtaining a feature of the passer-by different from the second image if there is a plurality of the candidates, of which the degree of match is equal to or more than a predetermined value calculated by the match degree calculating section, and a matched registrant selecting section for selecting the registrant from the plurality of candidates, of which the degree of match is equal to or more than the predetermined value, based on the feature of the passer-by obtained by the feature obtaining section.

The passer-by collating section may further include a feature storing section for storing in advance a plurality of authentication features and a feature amount of each of the authentication features for each of the candidates of the passer-by, the authentication feature and the feature amount corresponding to each other and a feature selecting section for selecting one of the plurality of authentication features stored by the feature storing section, variance of feature amounts of the plurality of candidates with respect to the authentication feature to be selected being largest, the degree of match of the plurality of candidates being equal to or more than the predetermined value, and the feature obtaining section obtains a feature of the passer-by, the feature corresponding to the authentication feature selected by the feature selecting section.

The photographing section may include a color filter, in which different colors correspond to adjacent pixels, and photograph a color image of the passer-by using the color filter when photographing the first image and a monochrome image of the passer-by without the color filter when photographing the second image.

The photographing section capable of photographing the passer-by at different angles may photograph the second image at a different angle from the first image. The photographing section may photograph the first image of the passer-by in a direction substantially parallel to a path, along which the passer-by passes, and the second image of the passer-by at a different angle from the first image.

According to a second aspect of the present invention, a computer readable medium storing thereon program for allowing a computer to function as a collation apparatus for selecting a registrant matched with a passer-by among a plurality of registrants registered in advance, wherein the collation apparatus includes a candidate searching section for searching a plurality of candidates for the registrant matched with the passer-by among the plurality of registrants based on a first image of the passer-by photographed by a photographing section and a passer-by collating section for selecting the registrant matched with the passer-by among the plurality of candidates based on a second image of the passer-by photographed by the photographing section when the passer-by is closer to the photographing section than when the first image is photographed.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows the configuration of a collation system 10 related to an exemplary embodiment of the present invention.

FIG. 2 shows the configuration of a collation apparatus 110 related to the present embodiment.

FIG. 3 shows a flow of the collation process of the collation apparatus 110 related to the present embodiment.

FIG. 4 shows the configuration of a collation apparatus 110 related to a first modified embodiment of the present invention.

FIG. 5 shows the configuration of a collation apparatus 110 related to a second modified embodiment of the present invention.

FIG. 6 shows the configuration of a collation apparatus 110 related to a third modified embodiment of the present invention.

FIG. 7 shows an example of the configuration of a photographing section 100.

FIG. 8 shows the configuration of a collation apparatus 110 related a fourth modified embodiment of the present invention.

FIG. 9 shows the configuration of a collation apparatus related a fifth modified embodiment of the present invention.

FIG. 10 shows the configuration of a computer 1200 related to an exemplary embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

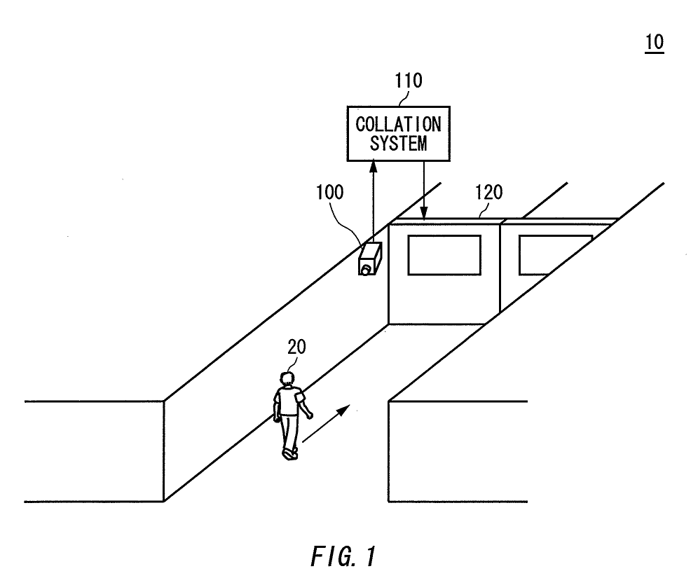

FIG. 1 shows the configuration of a collation system 10 related to an exemplary embodiment of the present invention. The collation system 10 is installed at an entrance, etc., through which a passer-by 20 passes to enter a company building, etc. Moreover, the collation system 10 authenticates that the passer-by 20 is one of a plurality of registrants registered in advance by selecting the one matched with the passer-by 20 based on the result of photographing the passer-by 20.

The collation system 10 includes a photographing section 100 for photographing a passer-by 20, a collation apparatus 110 for selecting one of a plurality of registrants matched with the passer-by 20 based on an image of the passer-by 20 photographed by the photographing section 100, and a-gate 120 for permitting the passer-by 20 to pass by opening a door based on an instruction of the collation apparatus 110 when the passer-by 20 is matched with one of the registrants. The photographing section 100 related to the present embodiment photographs the passer-by 20 at least twice, when the passer-by 20 is moving towards the collation apparatus 110. The collation apparatus 110 searches a plurality of candidates, one of which will be a person matched with the passer-by 20, among the plurality of registrants based on a first image of the passer-by 20 when photographing the first image. Moreover, the collation apparatus 110 selects one of the plurality of candidates matched with the passer-by 20 based on a second image of the passer-by 20 when photographing the second image. Accordingly, the collation system 10 can narrow the plurality of registrants down to the candidates while the passer-by 20 is moving towards the gate 120. Moreover, the collation system 10 can reduce the collation process time after the passer-by 20 approaches the gate 120 by selecting one of the candidates matched with the passer-by 20.

In addition, the photographing section 100 may include a color filter in which filters of different colors are applied to adjacent pixels, so that it can photograph the color image of the passer-by 20 using the color filter when photographing the first image and the monochrome image of the passer-by 20 when photographing the second image without the color filter. By this configuration, the photographing section 100 can photograph the first image of higher resolution than the second image. That is, although the photographing section 100 photographs one pixel with three photographing devices of RGB when photographing the first image, it can photograph the second image of high resolution because it photographs one pixel with one photographing device in case of the second image. Accordingly, it is possible to perform the collation with high precision by narrowing down the first image of low resolution efficiently using the candidates and performing the final collation using the second image of high resolution.

Moreover, the photographing section 100 capable of photographing the passer-by 20 at different angles may photograph the second image at different angles from the first image. For example, the photographing section 100 photographs the first image from a predetermined angle, estimates a relative position of the passer-by 20 and the photographing section 100 in case of photographing the second image based on the first image photographed, and determines an angle to photograph the second image based on the relative position when photographing the second image. In this case, the photographing section 100 may detect a position of an image of the passer-by 20 with respect to the first image, detect which side of a passage the passer-by 20 is passing through based on the position of the image, and determine which direction the second image is photographed in based on the passing position of the passer-by 20 detected when photographing the second images. The photographing section 100 may be installed to be capable of photographing the passer-by 20 from a plurality of positions in order to photograph the passer-by 20 at different angles. Moreover, the photographing section 100 may photograph the first image of the passer-by 20 in a direction substantially parallel to a path through which the passer-by 20 passes and the second image of the passer-by 20 at a different angle from the first image.

Moreover, the photographing section 100 may photograph a plurality of second images of the passer-by 20 from different angles. In this case, a plurality of registered images, which is the result of photographing each registrant at each angle, is given to the collation apparatus 110 in advance, and the photographing section 100 photographs the passer-by 20 from each angle. Moreover, the collation apparatus 110 compares the registered images with the second images for each photographed angle. By this control, it is possible to perform the collation on the passer-by 20 with high precision.

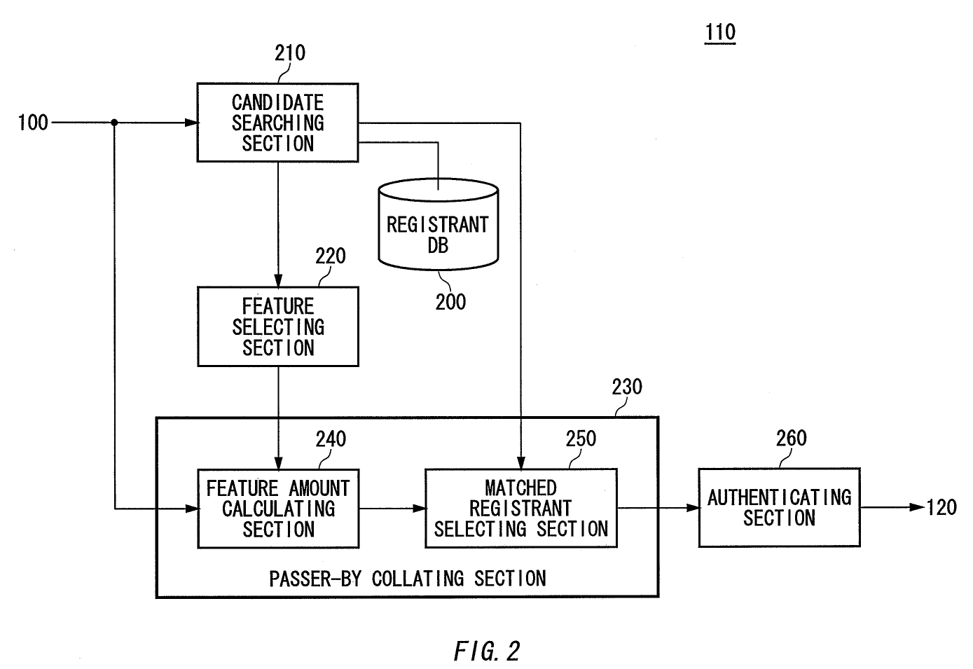

FIG. 2 shows the configuration of the collation apparatus 110 related to the present embodiment. The collation apparatus 110 includes a registrant database 200, a candidate searching section 210, a feature selecting section 220, a passer-by collating section 230, and an authenticating section 260.

The registrant database 200 stores a feature amount of each of the plurality of registrants for each of a plurality of predetermined features. The candidate searching section 210 searches a plurality of candidates for one of the plurality of registrants matched with the passer-by 20, based on the first image of the passer-by 20 photographed by the photographing section 100. The feature selecting section 220 selects a comparison feature to be compared to select one of the registrants matched with the passer-by based on the feature amount of each of the plurality of candidates for each of the plurality of features.

The passer-by collating section 230 selects one of the plurality of registrants matched with the passer-by 20 based on the second image of the passer-by 20. Here, the second image is an image of the passer-by 20 photographed by the photographing section 100 when the passer-by 20 is closer to the photographing section 100 than when the first image of the passer-by 20 is photographed. The passer-by collating section 230 includes a feature amount calculating section 240 and a matched registrant selecting section 250. The feature amount calculating section 240 calculates the feature amount of the passer-by 20 for the comparison feature from the second image. The matched registrant selecting section 250 selects one of the plurality of candidates matched with the passer-by 20 based on the result of comparing the feature amount of the passer-by 20 with the feature amount of each of the plurality of candidates for the comparison feature.

When the matched registrant selecting section 250 selects one of the registrants matched with the passer-by 20, the authenticating section 260 authenticates that the passer-by 20 is permitted to pass and outputs an instruction to open the door to the gate 120. The gate 120 receives the instruction and opens the door to allow the passer-by 20 to pass.

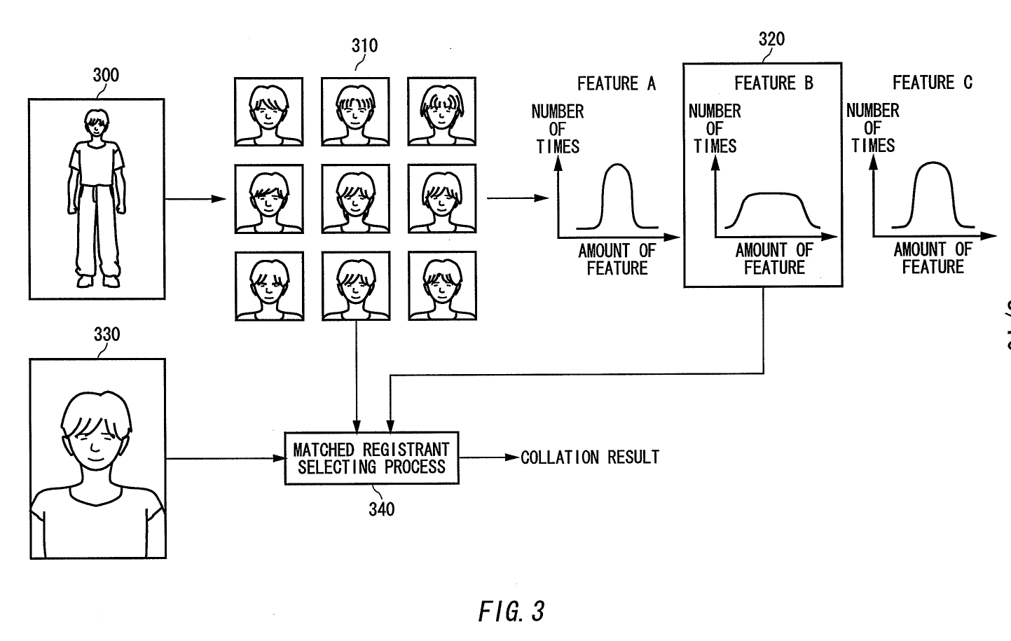

FIG. 3 shows a flow of the collation process of the collation apparatus 110 related to the present embodiment. First, the photographing section 100 photographs the first image 300. Next, candidate searching section 210 selects a plurality of candidates 310 among a plurality of registrants registered in the registrant database 200 based on the first image 300. In detail, the candidate searching section 210 may calculate the feature amount of the passer-by 20 for at least a part of the plurality of predetermined features from the first image 300, compare this feature amount with the feature amount of each registrant, and select registrants, of which the features are matched or similar, as the candidates 310. The feature herein may be a characteristic of a part of a body such as the outline of a face, the position, the width, the height, etc., of eyes, nose, mouth and ears of a face and so on, and the feature amount may be a numerical value representing the feature of the part of a body such as the width, the height, the curvature, etc.

Next, the feature selecting section 220 selects the comparison feature 320 to select a registrant matched with the passer-by 20 based on the feature amount of each of the plurality of candidates 310 for each of the plurality of features. The feature selecting section 220 related to the present embodiment selects one of the plurality of features as the comparison feature 320, with respect to which the variance of the feature amounts of the plurality of candidates 310 is larger than a predetermined value. For example, for the plurality of candidates 310, if the variance of the feature amount representing the position of eyes is larger than a predetermined value, the feature amount representing the position of eyes is selected as the comparison feature 320. Accordingly, the feature selecting section 220 can select a feature, by which the plurality of candidates 310 can be discriminated from each other more properly, as comparison feature 320.

Between the process of selecting candidates performed by the candidate searching section 210 and the process of selecting the comparison feature 320, the passer-by 20 is moving more closely to the photographing section 100 than when the first image is photographed. Here, the photographing section 100 photographs the second image 330 when the passer-by 20 is closer to the photographing section 100 than when the first image is photographed. Then, the feature amount calculating section 240 calculates the feature amount of the passer-by 20 for the comparison feature 320 from the second image 330. Then, the matched registrant selecting section 250 performs a matched registrant selecting process 340 to select one of the registrants matched with the passer-by 20 based on the feature amount of the passer-by 20 and the feature amount of each of the plurality of candidates for the comparison feature 320 and outputs the collation result to the authenticating section 260. In this process, the matched registrant selecting section 450 calculates a degree of match between the passer-by 20 and each candidate and selects one of the candidates, of which the degree of match with the passer-by 20 is largest and more than or equal to a predetermined threshold, as the registrant matched with the passer-by 20.

According to the collation system 10 as described above, it is possible to search a plurality of candidates 310 based on the first image 300 when the first image 300 is photographed and select a registrant matched with the passer-by 20 among the plurality of candidates 310 based on the second image 330 when the second image 330 is photographed. Accordingly, the collation system 10 can reduce the collating process time after the passer-by 20 approaches the gate 120. Moreover, according to the collation system 10, since it can narrow down the features used by the matched registrant selecting section 250 for the collation of the passer-by 20 and each candidate 310 by selecting them properly based on each feature amount of the plurality of candidates 310 for the plurality of features, it is possible to reduce the collating process time required by the matched registrant selecting section 250.

As above, the candidate searching section 210 may select the candidates 310 by comparing the feature amounts for some of the plurality of features extractable even if they have been photographed from a relatively far distance, e.g., the outline of a face, the positions of eyes, nose, mouth and ears, etc. Moreover, the feature selecting section 220 may select a feature amount which cannot be extracted from the first image 300 as the comparison feature 320, e.g., a feature amount representing the pattern of the iris of the passer-by 20 and perform comparison using the matched registrant selecting section 250.

Moreover, the candidate searching section 210 may select a plurality of candidates 310 based on the result of comparing the feature amount of each of the plurality of registrants with the feature amount of the passer-by 20 for a part of the plurality of features, and the feature selecting section 220 may select one of the registrants matched with the passer-by 20 based on the result of comparing the feature amount of each of the plurality of candidates 310 and the feature amount of the passer-by 20 for another part of the plurality of features. In this case, the feature selecting section 220 may select a registrant matched with the passer-by 20 among the plurality of candidates 310 based on the feature amounts for more features than those compared by the candidate searching section 210.

Moreover, the registrant database 200 may store the image of each of the plurality of registrants as the registered image in place of the amount of each of the plurality of registrants for the plurality of features. In this case, the candidate searching section 210 may calculate the feature amount for each of the plurality of features from a registered image of each registrant and select the candidate 310 by comparing this feature amount with the feature amount of the passer-by 20 calculated from the first image 300.

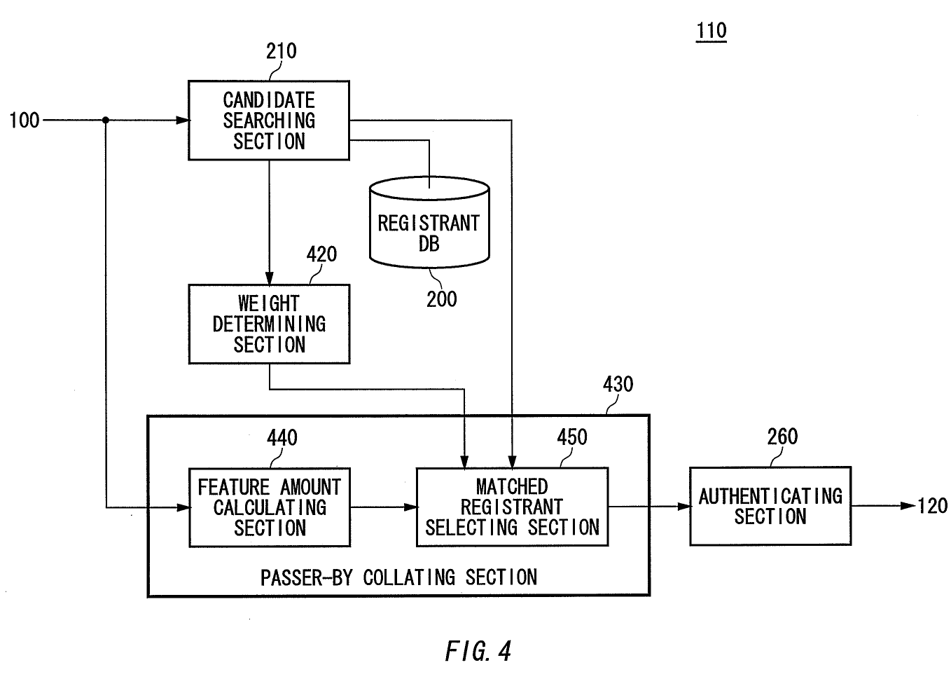

FIG. 4 shows the configuration of a collation apparatus 110 related to a first modified embodiment of the present invention. The collation apparatus 110 related to the first modified embodiment has the same configuration and function as those of the collation apparatus 110 described in connection with FIG. 2 except the following points, so the different points will be mainly described.

The collation apparatus 110 related to the first modified embodiment includes a registrant database 200, a candidate searching section 210, a weight determining section 420, a passer-by collating section 430, and an authenticating section 260. Here, the registrant database 200, the candidate searching section 210, and the authenticating section 260 have the same configurations and functions as those of the candidate searching section 210, and the authenticating section 260 shown in FIG. 2, so they will not be described.

The weight determining section 420 determines a weight given to each of the plurality of features, where the weight is used for selecting one of the registrants matched with the passer-by 20, based on the feature amount of each of the plurality of candidates for each of the plurality of predetermined features. Here, the weight determining section 420 may make the weight given to one of the plurality of features, of which the variance of the feature amounts of the plurality of candidates is relatively large, be larger than a weight given to another one of which the variance of the feature amounts of the plurality of candidates is relatively small.

The passer-by collating section 430 includes a feature amount calculating section 440 and a matched registrant selecting section 450, selecting a registrant matched with the passer-by 20 among the plurality of candidates based on the second image of the passer-by 20 photographed by the photographing section 100 when the passer-by 20 is closer to the photographing section 100 than when the first image is photographed. The feature amount calculating section 440 calculates the feature amount of the passer-by 20 for each of the plurality of features from the second image. The matched registrant selecting section 450 selects a registrant matched with the passer-by 20 among the plurality of candidates based on both the result of comparing the feature amount of the passer-by 20 with the feature amount of each of the plurality of candidates for each of the plurality of features and the weight given to the feature. In detail, the matched registrant selecting section 450 may calculate a value, which is the result of adding the product of the degree of match between the passer-by 20 and the candidate for each feature and the weight given to the feature to all of the comparison features, considering the value as the degree of match between the passer-by 20 and the candidate, and select one of the candidates, of which the degree of match is largest and more than or equal to a predetermined value, as the registrant matched with the passer-by 20.

According to the collation system 10 related to the first embodiment described above, the weight determining section 420 can make the weight given to a feature suitable for the comparison of the candidate selected by the candidate searching section 210 with the passer-by 20 be large and select the registrant matched with the passer-by 20 more properly. In addition, by making the weight given to the feature large, with respect to which the variance of the feature amounts of the plurality of the candidates is relatively large, it is possible to clearly discriminate and select the registrant matched with the passer-by 20.

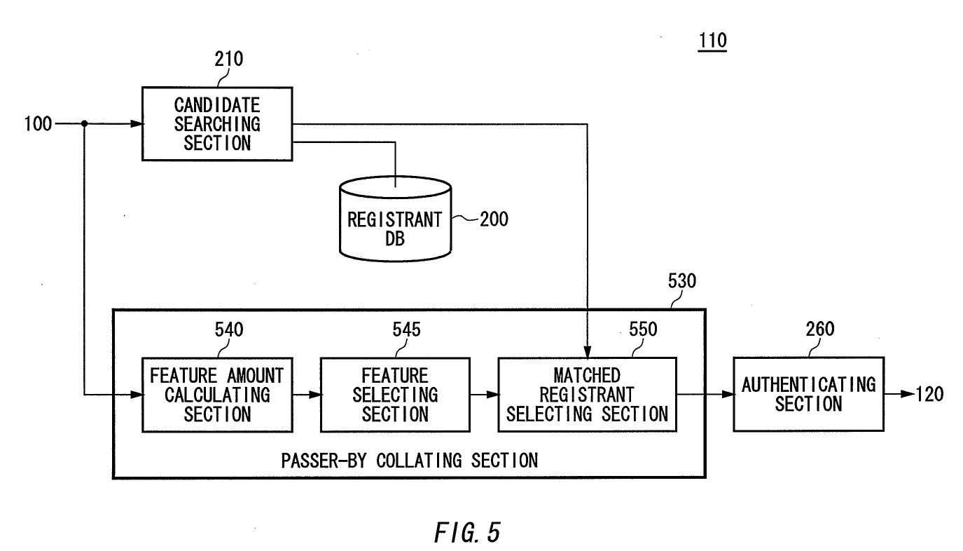

FIG. 5 shows the configuration of a collation apparatus 110 related to a second modified embodiment of the present invention. The collation apparatus 110 related to the second modified embodiment has the same configuration and function as those of the collation apparatus 110 described in connection with FIG. 2 except the following points, so the different points will be mainly described.

The collation apparatus 110 related to the second modified embodiment includes a registrant database 200, a candidate searching section 210, a passer-by collating section 530, and an authenticating section 260. Here, the registrant database 200, the candidate searching section 210, and the authenticating section 260 have the same configurations and functions as those of the candidate searching section 210, and the authenticating section 260 shown in FIG. 2, so they will not be described.

The passer-by collating section 530 includes a feature amount calculating section 540, a feature selecting section 545, and a matched registrant selecting section 550, selecting a registrant matched with the passer-by 20 among the plurality of candidates based on the second image of the passer-by 20 photographed by the photographing section 100 when the passer-by 20 is closer to the photographing section 100 than when the first image is photographed. The feature amount calculating section 540 calculates the feature amount of the passer-by 20 for each of the plurality of predetermined features from the second image. The feature selecting section 545 selects one of the plurality of features, with respect to which the deviation of the feature amount of the passer-by 20 from the feature amount of each of the plurality of registrants is largest, as the comparison feature to select the registrant matched with the passer-by 20. Here, the feature selecting section 545 may store the mean value and the variance of the feature amounts of the plurality of registrants in advance to calculate the deviation of the feature amount of the passer-by 20 based on the values. The matched registrant selecting section 550 selects the registrant matched with the passer-by 20 based on the feature amount of the passer-by 20 and the feature amount of each of the plurality of candidates for the comparison feature selected by the feature amount calculating section 540.

According to the collation system 10 related to the second modified embodiment described above, the passer-by 20 collating section 530 can properly select the registrant matched with the passer-by 20 among the plurality of candidates based on some of the plurality of predetermined features distinctive to the passer-by 20.

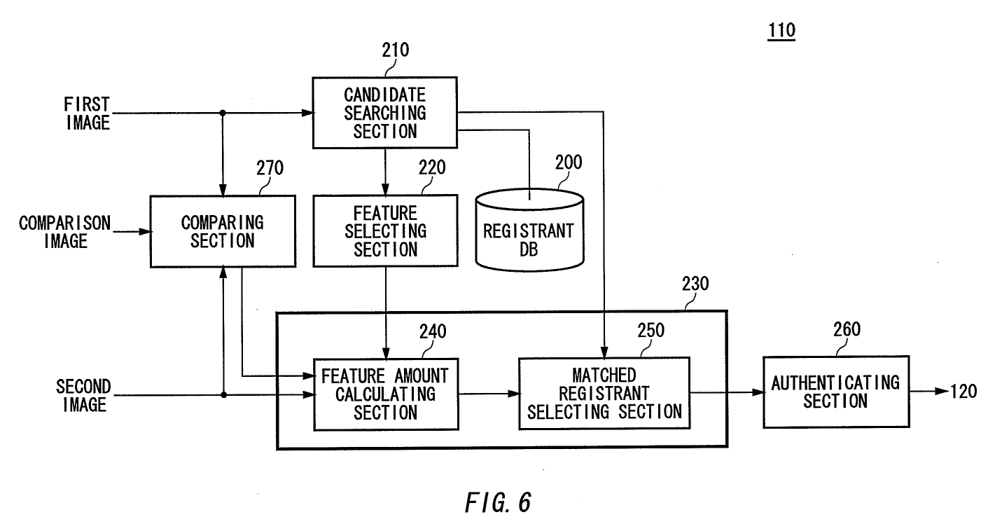

FIG. 6 shows the configuration of a collation apparatus 110 related to a third modified embodiment of the present invention. The collation apparatus 110 related to the present embodiment further includes a comparing section 270 in addition to the configuration of the collation apparatus 110 described in connection with FIG. 2. Other elements shown in FIG. 6 have the same or similar functions and configurations with those attached with the same symbols and described in connection with FIG. 2.

The comparing section 270 makes the first and second images of the same passer-by photographed correspond to each other. For example, the comparing section 270 may compare the first and second images photographed by the photographing section 100 and make the first and second images correspond to each other when the same passer-by is photographed. Moreover, the photographing section 100 may further photograph a comparison image to determine whether the same passer-by is photographed with respect to the first and second images. For example, the photographing section 100 may further photograph a comparison image, which is the result of photographing the passer-by so that the comparison image have substantially the same area as the first image, when photographing the second image. In this case, the comparing section 270 compares the first image with the comparison image and makes the first image correspond to the second image in response to the comparison image when the same passer-by is photographed.

Moreover, the comparing section 270 notifies the feature amount calculating section 240 of the first image to which each of the second images corresponds. The feature amount calculating section 240 calculates the feature amount corresponding to the comparison feature selected by the feature selecting section 220 for the first image corresponding to each of the second images with respect to the passer-by 20 of each of the second images. Moreover, the feature amount calculating section 240 notifies the matched registrant selecting section 250 of the feature amount and the first image to which the second image corresponds together with each of the second images.

The matched registrant selecting section 250 selects the registrant among a candidate group searched by the candidate searching section 210 for the first image corresponding to the second image received. That is, the matched registrant selecting section 250 selects the registrant matched with the passer-by 20 among the plurality of candidates based on the result of comparing, with respect to the comparison feature, the feature amount of the passer-by 20 on the second image with the feature amount of each of the plurality of candidates searched by the candidate searching section 210 on the first image corresponding to the second image. By making the first and second images correspond to each other, it is possible to perform the collation on each passer-by with high efficiency, even if photographing the first and second images in a different order for a plurality of passers-by.

In addition, the photographing section 100 photographs a passer-by of the first image and the comparison image of a broader area than that of the second image. That is, the magnification to the passer-by of the first image and the comparison image is smaller than that of the second image. For example, when the photographing section 100 photographs the iris of a passer-by as the second image and the collation is performed on the passer-by according to the image of the iris, the photographing section 100 may photograph the entire eyes of the passer-by as the first image and the comparison image. Moreover, when the photographing section 100 photographs the entire eyes of a passer-by as the second image and the collation is performed on the passer-by according to the image of the entire eyes, the photographing section 100 may photograph the area of the face and the upper half of the body of the passer-by as the first image and the comparison image.

As above, by performing the collation on a passer-by using the comparison image of a broader area, it is possible to easily perform the collation. For example, the comparing section 270 may perform the collation on the passer-by comparing the clothes of the passer-by photographed on each of the first image and the comparison image. Since it is usual to photograph the first image and the comparison image on the same day, the same clothes are photographed on the first image and the comparison image for the same passer-by. By comparing the patterns of the clothes, it is possible to extremely easily extract the first and second images of the same passer-by photographed and perform the collation on each passer-by with high efficiency. Moreover, since the final collation on the passer-by is performed using the second image of higher precision than the first image and the comparison image, it is possible to perform the collation on the passer-by with high precision.

In addition, if a plurality of passers-by is photographed on one first image, the candidate searching section 210 extracts candidates for each passer-by. Moreover, the comparing section 270 may compare each passer-by of the first image with the passer-by photographed on each of the second images with the described method. In this case, it is desirable that the photographing section 100 photographs the second image for each passer-by of the first image. Moreover, the matched registrant selecting section 250 selects the registrant from the candidates searched by the candidate searching section 210 for the passer-by corresponding to each of the second images.

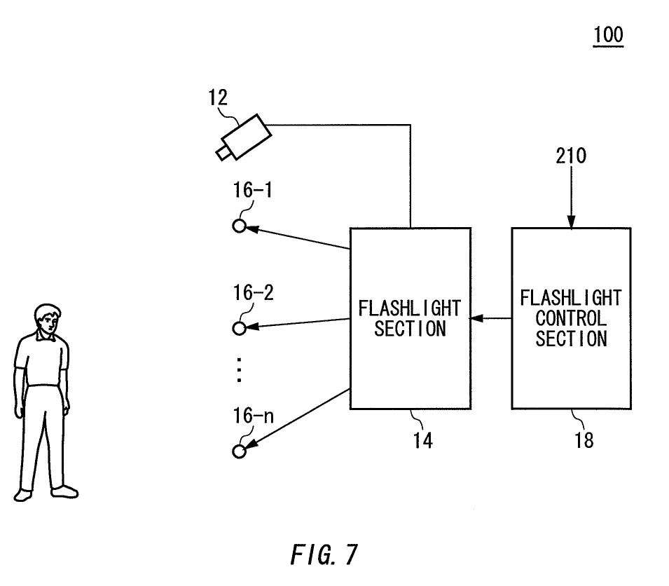

FIG. 7 shows an example of the configuration of the photographing section 100. The photographing section 100 includes a camera 12, a flashlight section 14, and a flashlight control section 18. In this embodiment, the camera 12 is an apparatus for photographing the still image of a passer-by. Moreover, the flashlight section 14 projects light onto the passer-by from a plurality of positions (16-1 to 16-n) synchronized with the operation of the camera 12 photographing the passer-by. Moreover, the flashlight control section 18 controls the position of the flashlight section 14 to project light and the intensity of the light projected by the flashlight section 14.

The candidate searching section 210 calculates the height of the passer-by based on the position of the passer-by with respect to the first image. The flashlight control section 18 calculates the position of the flashlight section 14 to project light in the vertical direction based on the height. That is, the flashlight control section 18 calculates the height of a part of the passer-by to be photographed as the second image based on the height of the passer-by and then the position of the flashlight section 14 to project light based on the height.

Moreover, the candidate searching section 210 may detect the brightness of the first image, and the flashlight control section 18 may control the position of the flashlight section 14 to project light and the intensity of the light projected by the flashlight section 14 based on the brightness of the first image. For example, if the brightness of the first image is low, the flashlight control section 18 increases the intensity of the light projected by the flashlight section 14. Moreover, if the brightness of an upper part of the first image is low, the flashlight control section 18 raises the position of the flashlight section 14 to project light.

In addition, the candidate searching section 210 may detect the brightness or contrast of a featured part of the passer-by used for the collation of the matched registrant selecting section 250, and the flashlight control section 18 may control the position of the flashlight section 14 to project light and the intensity of the light projected by the flashlight section 14 based on the brightness or contrast. That is, the flashlight control section 18 may control the position of the flashlight section 14 and the intensity of the light so that proper light can be projected onto the part. For example, if the brightness of the facial part of the passer-by of the first image is low, the flashlight control section 18 may raises the position of the flashlight section 14 to project light or increases the intensity of the light projected by the flashlight section 14. By these operations, it is possible to project flashlight of proper intensity from a proper position when photographing the second image of the passer-by 20.

Moreover, it is desirable, like the flashlight section 14, that the camera 12 can photograph the passer-by 20 at a plurality of heights. In this case, the candidate searching section 210 detects the position of the passer-by with respect to the first image and calculates the height to photograph the passer-by based on the position of the passer-by. Accordingly, the camera 12 photographs the second image of the passer-by at the height calculated. For example, the candidate searching section 210 may calculate the height of the passer-by based on the position of the passer-by with respect to the first image and photograph the second image of the passer-by at the position corresponding to the height.

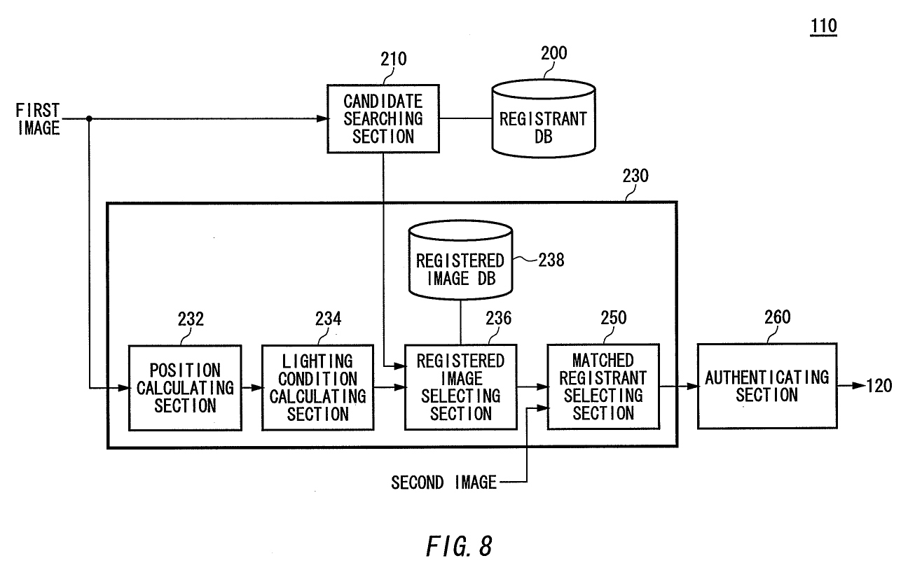

FIG. 8 shows the configuration of the collation apparatus 110 related a fourth modified embodiment of the present invention. The collation apparatus 110 related to the present embodiment includes a candidate searching section 210, a registrant database 200, a passer-by collating section 230, and an authenticating section 260. Moreover, the passer-by collating section 230 includes a position calculating section 232, a lighting condition calculating section 234, a registered image selecting section 236, a registered image database 238, and a matched registrant selecting section 250. Elements in FIG. 8 given the same symbols as those in FIG. 2 have the same or similar functions and configurations with those described in connection with FIG. 2.

The passer-by collating section 230 related to the present embodiment performs the collation on a passer-by based on a registered image in response to the lighting condition of the second image. For example, the lighting condition may be calculated based on the position of the flashlight section 14 of the photographing section 100 or the position of the passer-by. Moreover, the lighting condition represents the intensity or angle of the light projected onto the passer-by.

The passer-by collating section 230 includes a position calculating section 232, a lighting condition calculating section 234, a registered image selecting section 236, a registered image database 238, and a matched registrant selecting section 250. The registered image database 238 stores a plurality of registered images photographed in advance under different conditions for each candidate.

The position calculating section 232 calculates the position of the passer-by when the photographing section 100 photographs the passer-by based on the first image. For example, the position calculating section 232 detects which side of a passage the passer-by is walking along based on the first image.

Moreover, the lighting condition calculating section 234 calculates the lighting condition when the photographing section 100 photographs the passer-by based on the position of the passer-by calculated by the position calculating section 232. It is desirable that the direction and intensity of the light projected onto the passer-by are given in advance when the second image is photographed. From the walking position of the passer-by, the direction of light and the intensity of light, the lighting condition when the second image is photographed can be calculated. Moreover, the registered image selecting section 236 selects a registered image corresponding to the lighting condition calculated by the lighting condition calculating section 234 from the registered image database for each candidate searched by the candidate searching section 210. The matched registered selecting section 250 selects the registrant matched with the passer-by on the second image by comparing the registered image selected by the registered image selecting section 236 and the second image.

For example, although the angle of the light projected onto the passer-by when the second image is photographed is different depending upon the side, left or right, of a passage the passer-by 20 is walking along, according to the passer-by collating section 230 of the present embodiment, a registered image of the passer-by corresponding to the lighting condition can be selected, so it is possible to perform authentication on the passer-by with high precision. Moreover, by judging the lighting condition in advance based on the first image during the time from when the first image is photographed to the time when the second image is photographed, it is possible to select the registered image corresponding to the lighting condition in advance and perform authentication with high efficiency.

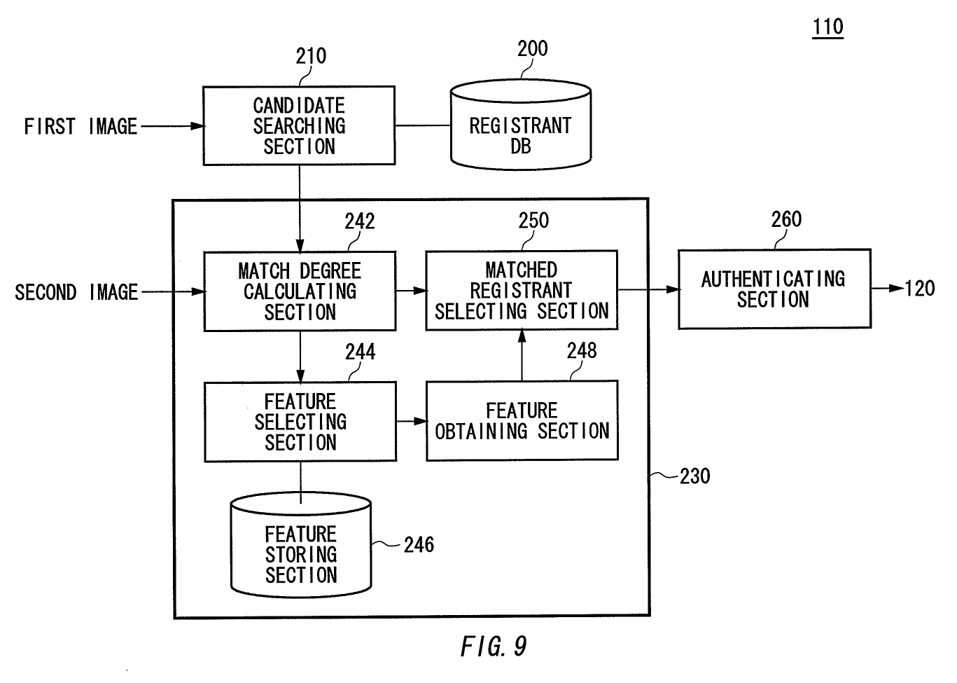

FIG. 9 shows the configuration of the collation apparatus 110 related a fifth modified embodiment of the present invention. The collation apparatus 110 related to the present embodiment includes a candidate searching section 210, a registrant database 200, a passer-by collating section 230, and an authenticating section 260. Moreover, the passer-by collating section 230 includes a match degree calculating section 242, a feature selecting section 244, a feature storing section 24G, a feature obtaining section 248, and a matched registrant selecting section 250. Elements in FIG. 8 given the same symbols as those in FIG. 2 have the same or similar functions and configurations with those described in connection with FIG. 2. The collation apparatus 110 further obtains other features different from the second image to perform the collation based on the features obtained, if a plurality of candidates, of which a degree of match is equal to or larger than a predetermined value, remains with respect to the passer-by collating section 230.

The match degree calculating section 242 calculates the degree of match between the passer-by on each second image and each candidate of a candidate group given by the candidate searching section 210 in response to the passer-by. The degree of match is calculated by comparing the registered image of a candidate with the second image of the passer-by.

The feature obtaining section 248 further obtains a feature of the passer-by different from the second image, if a plurality of candidates, of which the degree of match calculated by the match degree calculating section 242 is equal to or more than a predetermined value, exists for one passer-by. For example, the feature obtaining section 248 may make the photographing section 100 photograph a part of the passer-by different from the second image or further obtain voice information of the passer-by.

The feature storing section 246 stores in advance a plurality of authentication features and the feature amount of each of the authentication features for each candidate so that the authentication features and the feature amounts correspond to each other. Moreover, the authentication features and the feature amounts are stored to correspond to each candidate. Moreover, as the authentication features, images of a passer-by in which photographed angles are different or color or monochrome images of a passer-by may be stored.

In addition, the feature amount of the authentication feature is a value indicating how easily an authentication feature is discriminated from other authentication features when they are compared and may be a value indicating how many features, by which an authentication feature is discriminated from other authentication features, there are. For example, if the authentication feature is voice information, it may be a value indicating how many distinctive pronunciations of the authentication feature there are or how much the pronunciation is distinctive to other authentication features.

The feature selecting section 244 selects one of the plurality of authentication features stored by the feature storing section 246, wherein the variance of the feature amounts of a plurality of candidates is largest and the degree of match the candidates is a predetermined value or more. That is, the feature selecting section 244 extracts some of the plurality of authentication features stored in advance by the feature storing section 246 for all of the plurality of candidates and calculates the variance of the feature amounts among the plurality of candidates for each authentication feature extracted. The variance of the feature amounts of the authentication features is obtained by an equation in statistics. Moreover, the feature selecting section 244 notifies the feature obtaining section 248 of the feature amount of each candidate for the authentication feature and allows the feature obtaining section 248 to obtain the feature of the passer-by corresponding to the authentication feature. Moreover, the feature obtaining section 248 notifies the matched registrant selecting section 250 of the feature amount of each candidate and the feature amount of the passer-by for the authentication feature.

The matched registrant selecting section 250 performs the collation on the passer-by from a plurality of candidates of which the degree of match is a predetermined value or more based on the result of comparing the feature of the passer-by obtained by the feature obtaining section 248 with the authentication feature selected by the feature selecting section 244 for the plurality of candidates. By this control, it is possible to perform the collation on the passer-by with high precision.

In addition, the collation apparatus 110 may be a suitable combination of the configurations described in connection with FIGS. 2 to 9. For example, the collation apparatus 110 described in connection with FIG. 9 may further include the comparing section 270 described in connection with FIG. 6.

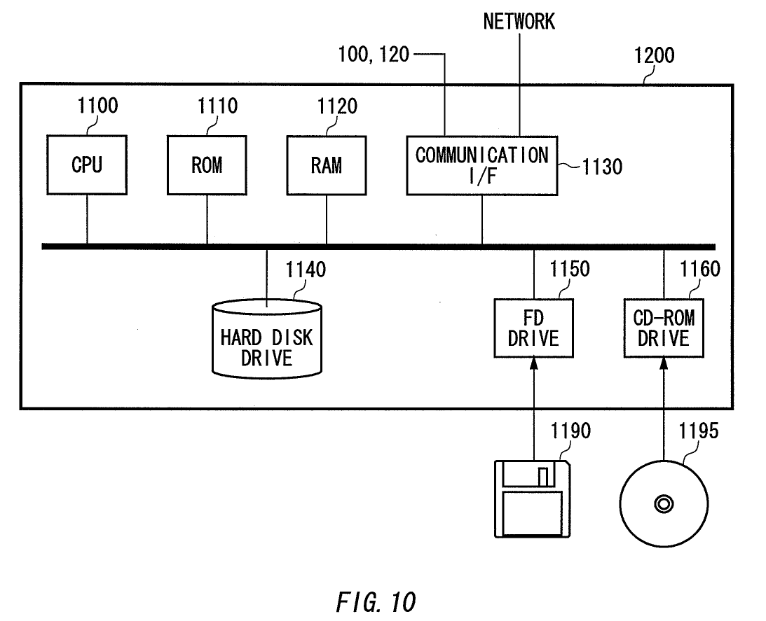

FIG. 10 shows the configuration of a computer 1200 related to an exemplary embodiment of the present invention. The computer 1200 related to the present embodiment includes a CPU 1100, a ROM 1110, a RAM 1120, a communication interface 1130, a hard disk drive 1140, a flexible disk drive 1150, and a CD-ROM drive 1160.

The CPU 1100 operates based on a program stored in the ROM 1110 and the RAM 1120 to control the parts. The ROM 1110 stores a boot program executed by the CPU 1100 when the computer 1200 starts or a program dependent of the hardware of the computer 1200. The RAM 1120 stores a program executed by the CPU 1100 and data used by the CPU 1100. The communication interface 1130 communicates with other apparatuses via a communication network. Moreover, the photographing section 100 and the gate 120 are coupled to the communication interface 1130 via the communication network. The hard disk drive 1140 stores a program and data used by the computer 1200 to provide them to the CPU 1100 via RAM 1120. The registrant database 200 shown in FIG. 2 may be installed on the hard disk drive 1140. The flexible disk drive 1150 reads the program or data from a flexible disk 1190 and provides it to the RAM 1120. The CD-ROM drive 1160 reads the program or data from a CD-ROM 1195 and provides it to the RAM 1120.

The program provided to the CPU 1100 via the RAM 1120 is stored on a recording medium such as the flexible disk 1190, the CD-ROM 1195, an IC card, etc., and provided by a user. The program is read from the recording medium, installed on the computer 1200 via the RAM 1120, and executed by the computer 1200.

The program installed and executed by the computer 1200 and allowing the computer 1200 to function as the collation apparatus 110 related to the exemplary embodiment of the present invention includes a candidate searching module, a feature selecting module, a passer-by collating module including a feature amount calculating module and a matched registrant selecting module, and an authenticating module. These programs or modules allow the computer 1200 to function as the candidate searching section 210, the feature selecting section 220, the passer-by collating section 230 including the feature amount calculating section 240 and the matched registrant selecting section 250, and the authenticating section 260 respectively.

Moreover, the program installed and executed by the computer 1200 and allowing the computer 1200 to function as the collation apparatus 110 related to the first modified embodiment of the present invention includes a candidate searching module, a weight determining module, a passer-by collating module including a feature amount calculating module and a matched registrant selecting module, and an authenticating module. These programs or modules allow the computer 1200 to function as the candidate searching section 210, the weight determining section 420, the passer-by collating section 430 including the feature amount calculating section 440 and the matched registrant selecting section 450, and the authenticating section 260 respectively.

Moreover, the program installed and executed by the computer 1200 and allowing the computer 1200 to function as the collation apparatus 110 related to the second modified embodiment of the present invention includes a candidate searching module, a passer-by collating module including a feature amount calculating module, a feature selecting module, and a matched registrant selecting module, and an authenticating module. These programs or modules allow the computer 1200 to function as the candidate searching section 210, the passer-by collating section 530 including the feature amount calculating section 540, the feature selecting section, and the matched registrant selecting section 550, and the authenticating section 260 respectively.

The programs or modules described above may be stored on an external recording medium. As the recording medium, in addition to the flexible disk 1190 and the CD-ROM 1195, an optical recording medium such as a DVD or PD, a magneto-optical recording medium such as an MO, a tape medium, a semiconductor memory such as an IC card, etc. can be used. In addition, by way of a storing device such as a hard disk or a RAM provided in a server system coupled to the dedicated network or the Internet as the recording medium, the program may be provided to the computer 1200 from an external network via the communication network.

According to the present invention, it is possible to realize the collating process on a passer-by with a plurality of registrants with higher efficiency.

Although the present invention has been described by way of exemplary embodiments, it should be understood that those skilled in the art might make many changes and substitutions without departing from the spirit and the scope of the present invention which is defined only by the appended claims.

1. A collation system for selecting a registrant matched with a passer-by among a plurality of registrants registered in advance, comprising:
a photographing section for photographing said passer-by;
a candidate searching section for searching a plurality of candidates for said registrant matched with said passer-by among said plurality of registrants based on a first image of said passer-by photographed by said photographing section; and
a passer-by collating section for selecting said registrant matched with said passer-by among said plurality of candidates based on a second image of said passer-by photographed by said photographing section when said passer-by is closer to said photographing section than when said first image is photographed.

2. A collation system as claimed in claim 1 further comprising a feature selecting section for selecting a comparison feature among a plurality of predetermined features, said comparison feature being compared to select said registrant matched with said passer-by, based on a feature amount of each of said plurality of candidates for each of said plurality of features,
wherein said passer-by collating section comprises:
a feature amount calculating section for calculating a feature amount of said passer-by for said comparison feature from said second image; and
a matched registrant selecting section for selecting said registrant matched with said passer-by among said plurality of candidates based on a result of comparing said feature amount of said passer-by with said feature amount of each of said plurality of candidates with respect to said comparison feature.

3. A collation system as claimed in claim 2, wherein said feature selecting section selects one of said plurality of features as said comparison feature, with respect to which variance-of feature amounts of said plurality of candidates is larger than a predetermined value.

4. A collation system as claimed in claim 1 further comprising a weight determining section for determining a weight given to each of a plurality of predetermined features, said weight being used to select said registrant matched with said passer-by, based on a feature amount of each of said plurality of candidates for each of said plurality of features,
wherein said passer-by collating section comprises:
a feature amount calculating section for calculating a feature amount of said passer-by for each of said plurality of features from said second image; and
a matched registrant selecting section for selecting said registrant matched with said passer-by among said plurality of candidates based on both a result of comparing said feature amount of said passer-by with said feature amount of each of said plurality of candidates with respect to each of said plurality of features and said weight given to each feature.

5. A collation system as claimed in claim 4, wherein said weight determining section makes a weight given to one of said plurality of features, with respect to which variance of feature amounts of said plurality of candidates is relatively large, be larger than a weight given to another one of said plurality of features, with respect to which variance of feature amounts of said plurality of candidates is relatively small.

6. A collation system as claimed in claim 1, wherein said passer-by collating section comprises:
a feature amount calculating section for calculating a feature amount of said passer-by for each of a plurality of predetermined features from said second image;
a feature selecting section for selecting one of said plurality of features, with respect to which deviation of said feature amount of said passer-by from a feature amount of each of said plurality of registrants is largest, as a comparison feature to be compared to select said registrant matched with said passer-by; and
a matched registrant selecting section for selecting said registrant matched with said passer-by based on said feature amount of said passer-by and a feature amount of each of said plurality of candidates with respect to said comparison feature.

7-18. (canceled)

19. A collation system as claimed in claim 1, wherein said passer-by collating section comprises:
a match degree calculating section for calculating a degree of match between said passer-by and each of said candidates based on said second image;
a feature obtaining section for further obtaining a feature of said passer-by different from said second image if there is a plurality of said candidates, of which said degree of match is equal to or more than a predetermined value calculated by said match degree calculating section; and
a matched registrant selecting section for selecting said registrant from said plurality of candidates, of which said degree of match is equal to or more than said predetermined value, based on said feature of said passer-by obtained by said feature obtaining section.

20. A collation system as claimed in claim 19, wherein said passer-by collating section further comprises:
a feature storing section for storing in advance a plurality of authentication features and a feature amount of each of said authentication features for each of said candidates of said passer-by, said authentication feature and said feature amount corresponding to each other; and
a feature selecting section for selecting one of said plurality of authentication features stored by said feature storing section, variance of feature amounts of said plurality of candidates with respect to said authentication feature to be selected being largest, said degree of match of said plurality of candidates being equal to or more than said predetermined value, and
said feature obtaining section obtains a feature of said passer-by, said feature corresponding to said authentication feature selected by said feature selecting section.

21-23. (canceled)

24. A computer readable medium storing thereon program for allowing a computer to function as a collation apparatus for selecting a registrant matched with a passer-by among a plurality of registrants registered in advance, said collation apparatus comprising:
a candidate searching section for searching a plurality of candidates for said registrant matched with said passer-by among said plurality of registrants based on a first image of said passer-by photographed by a photographing section; and
a passer-by collating section for selecting said registrant matched with said passer-by among said plurality of candidates based on a second image of said passer-by photographed by said photographing section when said passer-by is closer to said photographing section than when said first image is photographed.
